(19) United States
(12) Patent Application Publication
(10) Pub. No.: US 2016/0234378 A1
(43) Pub. Date: Aug. 11, 2016

(54) TERMINAL AND TERMINAL MANAGEMENT METHOD

(71) Applicant: Yulong Computer Telecommunication Scientific (Shenzhen) Co., Ltd., Shenzhen (CN)

(72) Inventor: Cuicui Tian, Shenzhen (CN)

(21) Appl. No.: 15/132,640

(22) Filed: Apr. 19, 2016

Related U.S. Application Data
(63) Continuation of application No. PCT/CN2013/087303, filed on Nov. 18, 2013.

(51) Int. Cl. H04M 1/725; G06K 9/00

(52) U.S. Cl. CPC H04M 1/72577; H04M 1/72569; G06K 9/00597

(57) ABSTRACT

Provided is a terminal, comprising: an acquisition unit which acquires the moving speed of the terminal; a determination unit which is used for determining whether a user of the terminal gazes upon a screen of the terminal when the moving speed is greater than or equal to a first moving speed and is less than or equal to a second moving speed; and a processing unit which performs a corresponding security processing operation when the determination result of the determination unit is yes. Correspondingly, also provided is a terminal management method. Corresponding reminding and limitation can be performed when a user plays with a mobile phone while walking so as to guarantee the personal security of the user.

### CROSS-REFERENCE TO RELATED APPLICATIONS

This application is a continuation of application PCT/CN2013/087303, by YULONG COMPUTER TELECOMMUNICATION SCIENTIFIC (SHENZHEN) CO., LTD., filed on Nov. 18, 2013, and entitled TERMINAL AND TERMINAL MANAGEMENT METHOD, the content of which is incorporated herein by reference in its entirety.

### TECHNICAL FIELD

The present disclosure relates to technical field of communication, and particularly, relates to a VoIP data transmission method and a base station.

### BACKGROUND

With the development of mobile phone, more and more people like to play with a mobile phone while walking, which causes great danger to the personal security of a user; especially for kids on the way to school, it will be dangerous if they play with a mobile phone while walking.

However, with regard to the behavior that the user plays with a mobile phone while walking, the terminal in the related art has no reminder and restriction, which affects the personal security of the user seriously.

Therefore, it is desired to provide a new technical solution which can have a corresponding reminder or a restriction if the user plays with a mobile phone while walking, therefore, guarantee the personal security of the user.

### SUMMARY

The present disclosure provides new technical solutions, which can have a corresponding reminder or restriction if the user plays with a mobile phone while walking, therefore, guarantee the personal security of the user.

In view of this, the present disclosure provides a terminal, which comprises: an acquisition unit, configured to acquire the moving speed of the terminal; a determination unit, configured to determine whether a user of the terminal gazes upon a screen of the terminal when the moving speed is greater than or equal to a first moving speed and is less than or equal to a second moving speed; a processing unit, configured to perform a corresponding security processing operation if the determination result of the determination unit is yes.

In some implementations, it is determined whether the user of the terminal is in a walking state according to the moving speed of the terminal. The user will be in the walking state if the moving speed of the terminal is in a walking speed range, here determine whether the user is playing with a mobile phone and perform the corresponding security processing operation if it is determined that the user is playing with a mobile phone, thus to remind or restrict the dangerous behavior of playing with a mobile phone while walking and guarantee the personal security of the user.

In the above-mentioned implementations, preferably, the determination unit further comprises: an image collecting subunit, configured to collect a current image and acquire the image information of the current image; an image parsing subunit, configured to parse the image information and determine whether eye characteristics information is included in the image information according to the parse result, and determine whether the user of the terminal gazes upon the screen of the terminal according to the eye characteristics information if the eye characteristics information is included in the image information.

In some implementations, eye-tracing technology can be used to achieve the determination of whether the user gazes upon the screen of the terminal, that is, acquire the current image through a camera; the user cannot be gazing upon the screen of the terminal currently if there is no eye characteristic image included in the acquired current image; otherwise, determine the gaze direction and position etc. of the user according to the eye characteristic image if the eye characteristic image is included in the acquired current image, thereby determining whether the user gazes upon the screen of the terminal.

In the above-mentioned implementations, preferably, the processing unit is further configured to: start to count the gaze duration upon the screen of the user of the terminal if the determination result of the determination unit is yes, and perform the corresponding security processing operation if the duration exceeds a preset duration.

In some implementations, it is determined that the user plays with a mobile phone while walking after confirming that the user has gazed upon the screen of the mobile phone for a while during walking, and then the security processing operation will be performed, thus to ensure the accuracy of the determination result and avoid inconvenience caused by an erroneous determination.

In the above-mentioned implementations, preferably, the security processing operation comprises: initiating a security reminder, closing the data service of the terminal, and/or sending a preset massage to other preset terminals.

In some implementations, the security processing operation can be initiating a security reminder, such as sending a reminder message to the user to remind him should not play with a mobile phone while walking for his personal security. The security processing operation can also be closing the data service of the terminal automatically; in this way, the user will be forced to stop gazing upon a mobile phone. If the user who gazes upon a mobile phone while walking is a child, the security processing operation can also be sending a preset massage to other preset terminals, that is, sending a message to his or her parents etc. to remind the dangerous behavior. A person skilled in the art will understand that the security processing operation includes but is not limited to the above-mentioned operations; it can also be other operations, such as locking the screen automatically and powering off etc.

In the above-mentioned implementations, preferably, the terminal further comprises: a speed detecting unit, configured to detect and record the real-time speed of the terminal; a computing unit, configured to calculate the moving speed according to the recorded real-time speed.

In some implementations, in order to ensure the accuracy of the determination of the speed of the terminal, the speed can be collected in real time, and then calculate the average speed of a period of time (for example, two minutes) of the terminal and use the average speed as the moving speed of the terminal, thereby avoiding an erroneous determination and an erroneous operation of the terminal.

In the above-mentioned implementations, preferably, the terminal further comprises: a setting unit, configured to set the first moving speed, the second moving speed, and/or the security processing operation according to a received setting instruction.

In some implementations, the user or the manufacture can set a determination condition (i.e. the threshold of moving speed) of the walking state freely according to the requirements, and set the operation used to remind the user freely if it is determined that the user plays with a mobile phone while walking, thereby satisfying different requirements of different users and improving the user experience.

According to another aspect of the present disclosure, it is provided a terminal management method, it comprises: operation 202, acquiring the moving speed of the terminal; operation 204, determining whether a user of the terminal gazes upon a screen of the terminal when the moving speed is greater than or equal to a first moving speed and is less than or equal to a second moving speed; operation 206, performing a corresponding security processing operation when the determination result is yes.

In some implementations, it can be determined whether the user of the terminal is in a walking state according to the moving speed of the terminal. The user will be in the walking state if the moving speed of the terminal is in a walking speed range, here determine whether the user is playing with a mobile phone and perform the corresponding security processing operation if it is determined that the user is playing with a mobile phone, thus to remind or restrict the dangerous behavior of playing with a mobile phone while walking and guarantee the personal security of the user.

In the above-mentioned implementations, preferably, the operation 204 comprises: collecting a current image and acquiring the image information of the current image; analyzing the image information and determining whether eye characteristics information is included in the image information according to the parse result, and determining whether the user of the terminal gazes upon the screen of the terminal according to the eye characteristics information if the eye characteristics information is included in the image information.

In some implementations, eye-tracing technology can be used to achieve the determination of whether the user gazes upon the screen of the terminal, that is, acquire the current image through a camera; the user cannot be gazing upon the screen of the terminal currently if there is no eye characteristic image included in the acquired current image; otherwise, determine the gaze direction and position etc. of the user according to the eye characteristic image if the eye characteristic image is included in the acquired current image, thereby determining whether the user gazes upon the screen of the terminal.

In the above-mentioned implementations, preferably, the operation 206 further comprises: starting to count the gaze duration upon the screen of the user of the terminal if the determination result of the determination unit is yes, and performing the corresponding security processing operation if the duration exceeds a preset duration.

In some implementations, it can be determined that the user plays with a mobile phone while walking after confirming that the user has gazed upon the screen of the mobile phone for a while during walking, and then the security processing operation will be performed, thus to ensure the accuracy of the determination result and avoid inconvenience caused by an erroneous determination.

In the above-mentioned implementations, preferably, the security processing operation comprises: initiating security reminder, closing the data service of the terminal, and/or sending a preset massage to other preset terminals.

In some implementations, the security processing operation can be initiating a security reminder, such as sending a reminder message to the user to remind him should not play with a mobile phone while walking for his personal security. The security processing operation can also be closing the data service of the terminal automatically; in this way, the user will be forced to stop gazing upon a mobile phone. If the user who gazes upon a mobile phone while walking is a child, the security processing operation can also be sending a preset massage to other preset terminals, that is, sending a message to his or her parents etc. to remind the dangerous behavior. A person skilled in the art will understand that the security processing operation includes but is not limited to the above-mentioned operations; it can also be other operations, such as locking the screen automatically and powering off etc.

In the above-mentioned implementations, preferably, before the operation 202, the method further comprises: detecting and recording the real-time speed of the terminal; calculating the moving speed according to the recorded real-time speed.

In some implementations, in order to ensure the accuracy of the determination of the speed of the terminal, the speed can be collected in real time, and then calculate the average speed of a period of time (for example, two minutes) of the terminal and use the average speed as the moving speed of the terminal, thereby avoiding an erroneous determination and an erroneous operation of the terminal.

In the above-mentioned implementations, preferably, the method further comprises: setting the first moving speed, the second moving speed, and/or the security processing operation according to a received setting instruction.

In some implementations, the user or the manufacture can set a determination condition (i.e. the threshold of moving speed) of the walking state freely according to the requirements, and set the operation used to remind the user freely if it is determined that the user plays with a mobile phone while walking, thereby satisfying different requirements of different users and improving the user experience.

According to some implementations of the present disclosure, it can be provided a program product stored in a non-volatile machine-readable medium for terminal management. The program product includes machine executable instructions, when executed by a computer system, causing the system to execute the following operations: acquiring the moving speed of the terminal; determining whether a user of the terminal gazes upon a screen of the terminal when the moving speed is greater than or equal to a first moving speed and is less than or equal to a second moving speed; performing a corresponding security processing operation when the determination result is yes.

According to some implementations of the present disclosure, it can be also provided a non-volatile machine-readable medium storing a program product for terminal management. The program product includes machine executable instructions, when executed by a computer system, causing the system to execute the following operations: acquiring the moving speed of the terminal; determining whether a user of the terminal gazes upon a screen of the terminal when the moving speed is greater than or equal to a first moving speed and is less than or equal to a second moving speed; performing a corresponding security processing operation when the determination result is yes.

According to some implementations of the present disclosure, it can be also provided a machine-readable program, configured to cause the machine to execute any of the terminal management methods described in the above-mentioned implementations.

According to some implementations of the present disclosure, it can be also provided a storage medium storing a machine-readable program. The machine-readable program can be configured to cause the machine to execute any of the terminal management methods described in the above-mentioned implementations.

By means of the above-mentioned technical solutions, corresponding reminding and restricting can be performed if a user plays with a mobile phone while walking so as to guarantee the personal security of the user.

### BRIEF DESCRIPTION OF THE DRAWINGS

FIG. 1 is a block diagram illustrating a terminal according to some implementations of the present disclosure;

FIG. 2 is a flowchart illustrating a terminal management method according to some implementations of the present disclosure;

FIG. 3 is a specific flowchart illustrating the terminal management method according to some implementations of the present disclosure;

FIG. 4 is a schematic diagram illustrating the interface of the terminal according to some implementations of the present disclosure.

### DETAILED DESCRIPTION

To understand the above-mentioned purposes, features, and advantages of the present disclosure more clearly, the present disclosure will be further described in detail below in combination with the accompanying drawings and the specific implementations. It should be noted that, the implementations of the present application and the features in the implementations can be combined with one another without conflicts.

Many specific details will be described below for sufficiently understanding the present disclosure. However, the present disclosure can also be implemented by adopting other manners different from those described herein. Accordingly, the protection scope of the present disclosure is not limited by the specific implementations disclosed below.

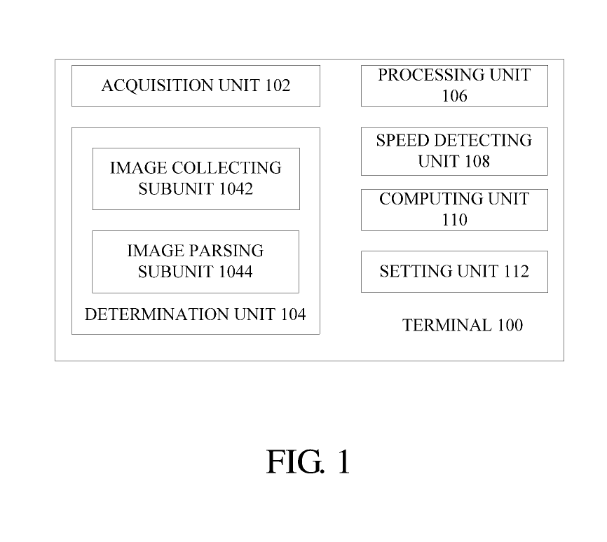

FIG. 1 is a block diagram illustrating a terminal according to some implementations of the present disclosure.

As shown in FIG. 1, a terminal 100 according to an implementation of the present disclosure comprises: an acquisition unit 102, configured to acquire the moving speed of the terminal; a determination unit 104, configured to determine whether a user of the terminal gazes upon a screen of the terminal when the moving speed is greater than or equal to a first moving speed and is less than or equal to a second moving speed; a processing unit 106, configured to perform a corresponding security processing operation when the determination result of the determination unit 104 is yes.

In the implementations, it can be determined whether the user of the terminal is in a walking state according to the moving speed of the terminal. The user will be in the walking state if the moving speed of the terminal is in a walking speed range, here determine whether the user is playing with a mobile phone and perform the corresponding security processing operation if it is determined that the user is playing with a mobile phone, thus to remind or restrict the dangerous behavior of playing with a mobile phone while walking and guarantee the personal security of the user.

In the above-mentioned implementations, preferably, the determination unit 104 further comprises: an image collecting subunit 1042, configured to collect a current image and acquire the image information of the current image; an image parsing subunit 1044, configured to parse the image information and determine whether eye characteristics information is included in the image information according to the parse result, and determine whether the user of the terminal gazes upon the screen of the terminal according to the eye characteristics information if the eye characteristics information is included in the image information.

In some implementations, eye-tracing technology can be used to achieve the determination of whether the user gazes upon the screen of the terminal, that is, acquire the current image through a camera; the user cannot gaze upon the screen of the terminal currently if there is no eye characteristic image included in the acquired current image; otherwise, determine the gaze direction and position etc. of the user according to the eye characteristic image if the eye characteristic image is included in the acquired current image, thereby determining whether the user gazes upon the screen of the terminal.

In the above-mentioned implementations, preferably, the processing unit 106 can be further configured to: start to count the gaze duration upon the screen of the user of the terminal if the determination result of the determination unit is yes, and perform the corresponding security processing operation if the duration exceeds a preset duration.

In the implementations, it can be determined that the user playing with a mobile phone while walking after confirming that the user has gazed upon the screen of the mobile phone for a while during walking, and then the security processing operation will be performed, thus to ensure the accuracy of the determination result and avoid inconvenience caused by an erroneous determination.

In the above-mentioned implementations, preferably, the security processing operation comprises: initiating a security reminder, closing the data service of the terminal, and/or sending a preset massage to other preset terminals.

In some implementations, the security processing operation can be initiating a security reminder, such as sending a reminder message to the user to remind him should not play with a mobile phone while walking for his personal security. The security processing operation can also be closing the data service of the terminal automatically; in this way, the user will be forced to stop gazing upon a mobile phone. If the user who gazes upon a mobile phone while walking is a child, the security processing operation can also be sending a preset massage to other preset terminals, that is, sending a message to his or her parents etc. to remind the dangerous behavior. A person skilled in the art will understand that the security processing operation includes but is not limited to the above-mentioned operations; it can also be other operations, such as locking the screen automatically and powering off etc.

In the above-mentioned implementations, preferably, the terminal 100 further comprises: a speed detecting unit 108, configured to detect and record the real-time speed of the terminal; a computing unit 110, configured to calculate the moving speed according to the recorded real-time speed.

In the implementations, in order to ensure the accuracy of the determination of the speed of the terminal, the speed can be collected in real time, and then calculate the average speed of a period of time (for example, two minutes) of the terminal and use the average speed as the moving speed of the terminal, thereby avoiding an erroneous determination and an erroneous operation of the terminal.

In the above-mentioned implementations, preferably, the terminal 100 further comprises: a setting unit 112, configured to set the first moving speed, the second moving speed, and/or the security processing operation according to a received setting instruction.

In some implementations, the user or the manufacture can set a determination condition (i.e. the threshold of moving speed) of the walking state freely according to the requirements, and set the operation used to remind the user freely if it is determined that the user plays with a mobile phone while walking, thereby satisfying different requirements of different users and improving the user experience.

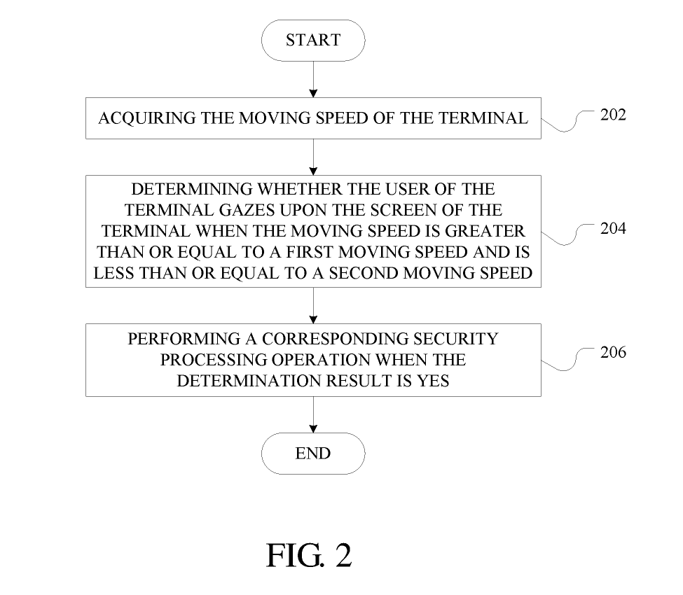

FIG. 2 is a flowchart illustrating a terminal management method according to some implementations of the present disclosure.

As shown in FIG. 2, the terminal management method according to an implementation of the present disclosure comprises: operation 202, acquiring the moving speed of the terminal; operation 204, determining whether a user of the terminal gazes upon a screen of the terminal when the moving speed is greater than or equal to a first moving speed and is less than or equal to a second moving speed; operation 206, performing a corresponding security processing operation when the determination result is yes.

In the implementations, it can be determined whether the user of the terminal is in a walking state according to the moving speed of the terminal. The user will be in the walking state if the moving speed of the terminal is in a walking speed range, here determine whether the user is playing with a mobile phone, and perform the corresponding security processing operation if it is determined that the user is playing with a mobile phone, thus to remind or restrict the dangerous behavior of playing with a mobile phone while walking and guarantee the personal security of the user.

In the above-mentioned implementations, preferably, the operation 204 comprises: collecting a current image and acquiring the image information of the current image; analyzing the image information and determining whether eye characteristics information is included in the image information according to the parse result, and determining whether the user of the terminal gazes upon the screen of the terminal according to the eye characteristics information if the eye characteristics information is included in the image information,

In some implementations, eye-tracing technology can be used to achieve the determination of whether the user gazes upon the screen of the terminal, that is, acquire the current image through a camera; the user cannot gaze upon the screen of the terminal currently if there is no eye characteristic image included in the acquired current image; otherwise, determine the gaze direction and position etc. of the user according to the eye characteristic image if the eye characteristic image is included in the acquired current image, thereby determining whether the user gazes upon the screen of the terminal.

In the above-mentioned implementations, preferably, the operation 206 further comprises: starting to count the gaze duration upon the screen of the user of the terminal if the determination result of the determination unit is yes, and performing the corresponding security processing operation if the duration exceeds a preset duration.

In the implementations, it can be determined that the user plays with a mobile phone while walking after confirming that the user has gazed upon the screen of the mobile phone for a while during walking, and then the security processing operation will be performed, thus to ensure the accuracy of the determination result and avoid inconvenience caused by an erroneous determination.

In the above-mentioned implementations, preferably, the security processing operation comprises: initiating a security reminder, closing the data service of the terminal, and/or sending a preset massage to other preset terminals.

In some implementations, the security processing operation can be initiating a security reminder, such as sending a reminder message to the user to remind him should not play with a mobile phone while walking for his personal security. The security processing operation can also be closing the data service of the terminal automatically; in this way, the user will be forced to stop gazing upon a mobile phone. If the user who gazes upon a mobile phone while walking is a child, the security processing operation can also be sending a preset massage to other preset terminals, that is, sending a message to his or her parents etc. to remind the dangerous behavior. A person skilled in the art will understand that the security processing operation includes but is not limited to the above-mentioned operations; it can also be other operations, such as locking the screen automatically and powering off etc.

In the above-mentioned implementations, preferably, before the operation 202, the method further comprises: detecting and recording the real-time speed of the terminal; calculating the moving speed according to the recorded real-time speed.

In some implementations, in order to ensure the accuracy of the determination of the speed of the terminal, the speed can be collected in real time, and then calculate the average speed of a period of time (for example, two minutes) of the terminal and use the average speed as the moving speed of the terminal, thereby avoiding an erroneous determination and an erroneous operation of the terminal.

In the above-mentioned implementations, preferably, the method further comprises: setting the first moving speed, the second moving speed, and/or the security processing operation according to a received setting instruction.

In some implementations, the user or the manufacture can set a determination condition (i.e. the threshold of moving speed) of the walking state freely according to the requirements, and set the operation used to remind the user freely if it is determined that the user plays with a mobile phone while walking, thereby satisfying different requirements of different users and improving the user experience.

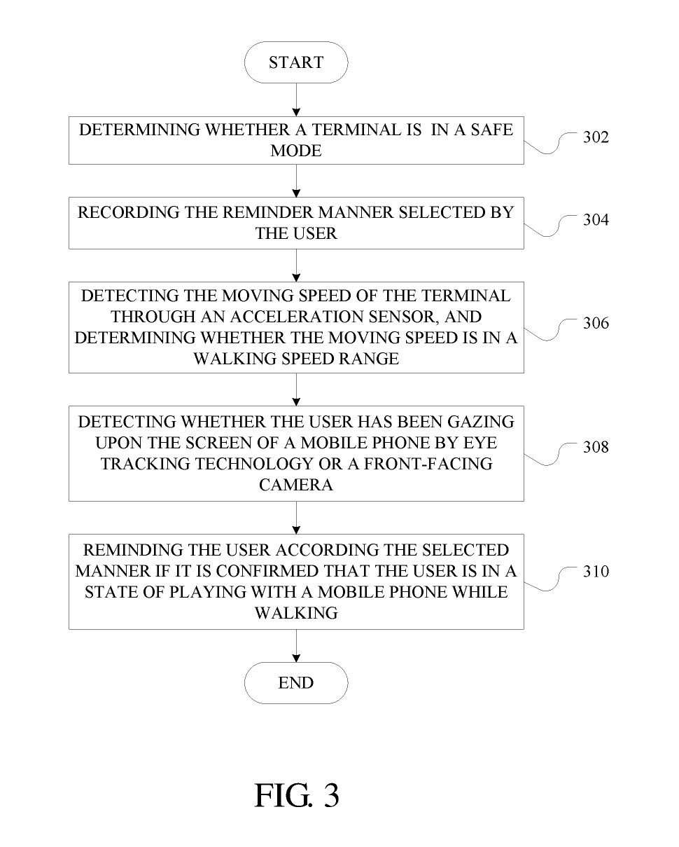

FIG. 3 is a specific flowchart illustrating a terminal management method according to some implementations of the present disclosure.

As shown in FIG. 3, the specific process of the terminal management method according to an implementation of the present disclosure comprises:

Operation 302, setting a safe mode (or walking mode) and a common mode for the user to select, and if it is determined that the user is in the safe mode (or walking mode), proceed to operation 304.

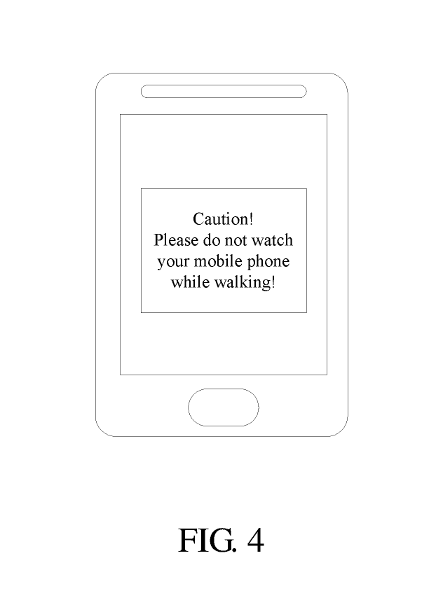

Operation 304, selecting a reminder manner by the user if the safe mode has been selected. The reminder manner includes but is not limited to the following: 1. displaying a reminder message, as shown in FIG. 4, to remind the user should not play with a mobile phone while walking for the personal security; 2. disabling a data network automatically: if it is detected that the user is in a state of playing with a mobile phone while walking, disabling the data network automatically to force the user to stop watching (or playing with) the mobile phone, and opening the data network automatically if the user is in another state; 3. sending a message to a fixed number automatically to remind a relevant person. For instance, if the user of the mobile phone is a child, a message will be sent to the mobile phone of his or her parents to remind the dangerous behavior.

Operation 306, detecting whether the user is in a walking state through an acceleration sensor by the terminal. The walking state can be determined by the moving speed of the user, normally the walking speed of the user will be in a range, and the moving speed of the user can be detected to determine whether the user is in a walking state.

Operation 308, determining whether the user is watching the mobile phone through eye tracing technology when it is determined that the user is in a walking state; when the determination result is yes, proceed to Operation 310. The duration that the user watches the mobile phone can also be recorded, and it is determined that the user plays with a mobile phone while walking after determining that the user has gazed upon the screen of the mobile phone for a while, and then perform the security processing operation, such that the accuracy of the determination result can be ensured and inconvenience caused by erroneous determination can be avoided.

Operation 310, reminding the user according to the manner selected in Operation 304 if it is confirmed that the user is in a state of playing with a mobile phone while walking. A person skilled in the art will understand that the security processing operation includes but is not limited to the above-mentioned operations; it can also be other operations, such as locking the screen automatically and powering off etc.

The implementations of the present disclosure have been illustrated in combination with the accompanying drawings. By means of the implementations of the present disclosure, the user will be reminded or restricted automatically if it is detected that the user plays with a mobile phone while walking, such that the risk caused by playing with a mobile phone while walking can be reduced and the personal security of the user can be ensured.

According to some implementations of the present disclosure, it is also provided a program product stored in a non-volatile machine-readable medium for terminal management. The program product includes machine executable instructions, when executed by a computer system, causing the system to execute the following operations: acquiring the moving speed of the terminal; determining whether a user of the terminal gazes upon a screen of the terminal when the moving speed is greater than or equal to a first moving speed and is less than or equal to a second moving speed; performing a corresponding security processing operation when the determination result is yes.

According to some implementations of the present disclosure, it can be also provided a non-volatile machine-readable medium storing a program product for terminal management. The program product includes machine executable instructions, when executed by a computer system (such as an apparatus comprises a memory and a processor), causing the system to execute the following operations: acquiring the moving speed of the terminal; determining whether a user of the terminal gazes upon a screen of the terminal when the moving speed is greater than or equal to a first moving speed and is less than or equal to a second moving speed; performing a corresponding security processing operation when the determination result is yes.

According to some implementations of the present disclosure, it can also provide a machine-readable program. The program can be configured to cause the machine to execute any of the terminal management methods described in the above-mentioned implementations.

According to some implementations of the present disclosure, it can be also provided a storage medium storing a machine-readable program, wherein, the machine-readable program can be configured to cause the machine to execute any of the terminal management methods described in the above-mentioned implementations.

The foregoing descriptions are merely preferred implementations of the present disclosure, rather than limiting the present disclosure. Various modifications and alterations can be made to the present disclosure for those skilled in the art. Any modification, equivalent substitution, improvement or the like made within the spirit and principle of the present disclosure shall fall into the protection scope of the present disclosure.

What is claimed is:

1. A terminal, comprising:
an acquisition unit configured to acquire a moving speed of the terminal;
a determination unit configured to determine whether a user of the terminal gazes upon a screen of the terminal when the moving speed is greater than or equal to a first moving speed and is less than or equal to a second moving speed; and
a processing unit configured to perform a corresponding security processing operation based on a determination that the user of the terminal gazes upon the screen of the terminal when the moving speed is greater than or equal to a first moving speed and is less than or equal to a second moving speed.

2. The terminal of claim 1, wherein the determination unit further comprises:
an image collecting subunit configured to collect a current image and acquire the image information of the current image; and
an image parsing subunit configured to parse the image information and determine whether eye characteristics information is included in the image information according to the parse result, and determine whether the user of the terminal gazes upon the screen of the terminal according to the eye characteristics information if the eye characteristics information is included in the image information.

3. The terminal of claim 2, further comprising:
a setting unit configured to set at least one of: the first moving speed, the second moving speed, and the security processing operation according to a received setting instruction.

4. The terminal of claim 1, wherein the processing unit is further configured to start to count the gaze duration upon the screen of the user of the terminal based on a determination that the user of the terminal gazes upon the screen of the terminal when the moving speed is greater than or equal to a first moving speed and is less than or equal to a second moving speed and perform the corresponding security processing operation if the duration exceeds a preset duration.

5. The terminal of claim 4, further comprising:
a setting unit configured to set at least one of: the first moving speed, the second moving speed, and the security processing operation according to a received setting instruction.

6. The terminal of claim 1, wherein the security processing operation comprises at least one of:
initiating a security reminder, closing the data service of the terminal, and sending a preset massage to other preset terminals.

7. The terminal of claim 1, further comprising:
a speed detecting unit configured to detect and record a real-time speed of the terminal; and
a computing unit configured to calculate the moving speed according to the recorded real-time speed.

8. The terminal of claim 1, further comprising:
a setting unit configured to set at least one of: the first moving speed, the second moving speed, and the security processing operation according to a received setting instruction.

9. A terminal management method, comprising:
acquiring a moving speed of the terminal;
determining whether a user of the terminal gazes upon a screen of the terminal when the moving speed is greater than or equal to a first moving speed and is less than or equal to a second moving speed; and
performing a corresponding security processing operation based on a determination that the user of the terminal gazes upon the screen of the terminal when the moving speed is greater than or equal to a first moving speed and is less than or equal to a second moving speed.

10. The terminal management method of claim 9, wherein determining whether a user of the terminal gazes upon a screen of the terminal when the moving speed is greater than or equal to a first moving speed and is less than or equal to a second moving speed comprises:
collecting a current image and acquiring the image information of the current image; and
analyzing the image information and determining whether eye characteristics information is included in the image information according to the parse result, and determining whether the user of the terminal gazes upon the screen of the terminal according to the eye characteristics information if the eye characteristics information is included in the image information.

11. The terminal management method of claim 10, further comprising:
setting at least one of: the first moving speed, the second moving speed, and the security processing operation according to a received setting instruction.

12. The terminal management method of claim 9, wherein performing a corresponding security processing operation based on a determination that the user of the terminal gazes upon the screen of the terminal when the moving speed is greater than or equal to a first moving speed and is less than or equal to a second moving speed further comprises:
starting to count the gaze duration upon the screen of the user of the terminal based on a determination that the user of the terminal gazes upon the screen of the terminal when the moving speed is greater than or equal to a first moving speed and is less than or equal to a second moving speed and performing the corresponding security processing operation if the duration exceeds a preset duration.

13. The terminal management method of claim 12, further comprising:
setting at least one of: the first moving speed, the second moving speed, and the security processing operation according to a received setting instruction.

14. The terminal management method of claim 9, wherein the security processing operation comprises at least one of:
initiating a security reminder, closing the data service of the terminal, and sending a preset massage to other preset terminals.

15. The terminal management method of claim 14, further comprising:
setting at least one of: the first moving speed, the second moving speed, and the security processing operation according to a received setting instruction.

16. The terminal management method of claim 9, before acquiring the moving speed of the terminal, further comprising:
detecting and recording a real-time speed of the terminal; and
calculating the moving speed according to the recorded real-time speed.

17. The terminal management method of claim 16, further comprising:
setting at least one of: the first moving speed, the second moving speed, and the security processing operation according to a received setting instruction.

18. The terminal management method of claim 9 further comprising:
setting at least one of: the first moving speed, the second moving speed, and the security processing operation according to a received setting instruction.

19. An apparatus, comprising:
a memory configured to store computer-readable program code; and
a processor configured to invoke the computer-readable program code to execute the following:
acquiring a moving speed of the terminal;
determining whether a user of the terminal gazes upon a screen of the terminal when the moving speed is greater than or equal to a first moving speed and is less than or equal to a second moving speed; and
performing a corresponding security processing operation based on a determination that the user of the terminal gazes upon the screen of the terminal when the moving speed is greater than or equal to a first moving speed and is less than or equal to a second moving speed.

20. A computer-readable storage medium configured to store computer-readable program code, the computer-readable program code running on an apparatus to execute the following:
acquiring the moving speed of the terminal;
determining whether a user of the terminal gazes upon a screen of the terminal when the moving speed is greater than or equal to a first moving speed and is less than or equal to a second moving speed; and
performing a corresponding security processing operation based on a determination that the user of the terminal gazes upon the screen of the terminal when the moving speed is greater than or equal to a first moving speed and is less than or equal to a second moving speed.
